(19) United States
(12) Patent Application Publication
(10) Pub. No.: US 2026/0218647 A1
(43) Pub. Date: Jul. 30, 2026

(54) VOLUMETRIC HEAT ENGINE WITH PISTON-PENDULUM

(71) Applicant: Abdelhakim LIMANE, Saint-Laurent (CA)

(72) Inventors: Abdelhakim LIMANE, Saint-Laurent (CA); Mustapha LIMANE, Réghaia (DZ)

(21) Appl. No.: 19/146,440

(22) PCT Filed: Jan. 8, 2023
(86) PCT No.: PCT/CA2023/050011

§ 371 Date: Jul. 8, 2025

(51) Int. Cl. F02B 75/04

(52) U.S. Cl. CPC F02B 75/04

(57) ABSTRACT

The present invention relates to a volumetric heat engine with a cycle derived from the Stirling cycle, or designed as an internal combustion engine. A pendulum-piston is mounted in a closed casing of almost parallelepiped shape to define at least one chamber there between. The piston pivots about an axis with a reciprocating rotary movement. The piston can be freely movable without any return spring. In the case of a Stirling cycle, the piston acts as both displacing piston and working piston. Cold and hot sources are located at opposite ends of the casing. In the case of an internal combustion engine, the heat engine is capable of operating in a two-stroke combustion cycle with uniflow scavenging of the gases burned by the air/fuel mixture.

### CROSS-REFERENCE TO RELATED APPLICATIONS

N/A

### FIELD OF THE INVENTION

The present invention relates to thermal machines or engines, and more particularly to a volumetric thermal machine or engine whose piston has a swing motion similar to a pendulum (reciprocating rotary movement).

### BACKGROUND OF THE INVENTION

In recent years, in the context of environmental awareness, the Stirling engine has regained a certain appeal, due to its excellent efficiency and its ability to exploit the less polluting natural thermal resources, which are moreover very diversified, as well as existing and unused thermal rejections.

### SUMMARY OF THE INVENTION

The present invention is a volumetric thermal machine or engine whose piston has a swing motion similar a pendulum (reciprocating rotary movement), or more appropriately called a pendulum-piston thermal machine. Furthermore, the present invention is based on the geometric asymmetry of the pendulum-piston, relative to its pivot axis.

Because of the geometric asymmetry, the resultant of the working gas pressure on the pendulum-piston is a torque on the main shaft (about the main axis) moving the pendulum-piston, thus the pendulum-piston plays the role of a power piston. On the other hand, the thermodynamic cycles of the gas in the working chambers (on either side of the plate defining the piston) are out of phase with each other by half a period. Due to this phase shift, the torque at the axis changes direction to cyclically alternate the rotational direction of movement without the need for a massive flywheel or return spring. In addition, the fact that the pendulum-piston pivots about the main axis, it pushes the gas from one arched side to the other for each working chamber moving the gas from one thermal source to the other in diametrically opposite sides of the main axis in the case of a thermal machine with a Stirling cycle, therefore the pendulum-piston also plays the role of the working gas displacer piston.

In such an embodiment, the housing is typically perfectly sealed. It is almost impossible for the gas to leak from the two working chambers to the outside environment or to be contaminated by the outside environment. In addition, pumping losses are inexistent and the noise is reduced, since the pendulum-piston is isolated from the outside environment.

Moreover, the pendulum-piston thermal machine can be made of flat and/or cylindrical surfaces for example, thus facilitating its machining. In addition, the pendulum-piston is typically supported only by ball bearings through its shaft, allowing the pendulum-piston to slide without pushing on the internal walls of the casing. Accordingly, all these characteristics allow:
to minimize lubrication needs;
to minimize friction losses;
to lower manufacturing tolerances; and
to manufacture the pendulum-piston thermal machine, at any scale from microscopic to macroscopic.

In addition, this machine can have a quasi-parallelepiped shape, such as a box, that can be modeled and sized as needed. This characteristic makes it possible to group several machines such as cells, whether to surround a thermal source or to spread them on a surface in order to constitute a panel by exposing said thermal sources on the surfaces of the panel.

Furthermore, the thermal machine is distinguished by the location of the hot and cold sources which are at opposite ends from one another (diametrically opposite one another relative to the main axis). This feature makes it possible to stack several machines in the form of layers so that the cold source of the first layer is essentially stuck to, or being the same as, the hot source of the second layer, and so on. This makes it possible to improve energy efficiency, as well as to do without a porous element typically in the form of a thermal regenerator or the like (see details hereinbelow), and to further reduce pressure drop when moving the gas between the thermal sources.

Several mechanisms can be used to convert the reciprocating rotary motion of the pendulum-piston into continuous rotary motion, as some examples are being detailed hereinbelow.

Advantageously, the configuration of this thermal machine provides the possibility of having the motion conversion mechanism isolated in a confined compartment far from thermal sources.

The pendulum-piston internal combustion engine is analogous to a super-square engine. The squish effect is accentuated with the pendulum-piston. In addition, the ratio between combustion speed (flame velocity) and pendulum-piston speed allows very high engine speeds to be reached without loss of torque. On the other hand, the gas displacement effect of the pendulum-piston accentuates the mixing of gases in front of the spark plug or fuel injector, thus improving the combustion process.

Other objects and advantages of the present invention will become apparent from a careful reading of the detailed description provided herein, with appropriate reference to the accompanying drawings.

### BRIEF DESCRIPTION OF THE DRAWINGS

The invention is explained with reference to the accompanying drawings. The illustrated embodiments do not represent a limitation to the variants shown but simply serve to explain the principle of the invention.

The figures show only very simplified basic representations devoid of components not essential to the explanation of the invention such as bolts and sealing piston ring, etc. However, this does not mean that such components are not present in a solution according to the invention.

FIG. 1 is a schematic exploded perspective view of the various essential components constituting a pendulum-piston thermal machine in accordance with an embodiment of the present invention, in a Sterling cycle version with hot and cold thermal sources directly anchored onto the casing, and equipped with a movement conversion mechanism whose dynamic behavior during the back and forth strokes of the piston-pendulum is identical.

FIG. 2 is a section view perpendicular to the main pivot axis, of the embodiment of the said pendulum-piston thermal machine of FIG. 1, along with cross-sectional surfaces of the minimum and maximum volumes of the right-hand side working chamber.

FIG. 3 is a schematic section view perpendicular to the main pivot axis, similar to FIG. 2, of another embodiment of a pendulum-piston thermal machine in accordance with an embodiment of the present invention, in a Sterling cycle version with motion conversion mechanism, equipped with heat exchangers such as in the left-hand side representation with a heater and a cooler shared for the two working chambers; and in the right-hand side representation with a heater and a cooler being dedicated to each working chamber.

FIG. 4 is a schematic front view of a motion conversion mechanism of the embodiment of FIG. 1 of the pendulum-piston thermal machine, whose dynamic behaviors during the back-and-forth strokes of the pendulum-piston are identical.

FIG. 5 is a schematic section view perpendicular to the main pivot axis, similar to FIG. 2, of another embodiment of a Sterling cycle pendulum-piston thermal machine, with the hot and cold thermal sources directly anchored onto the casing and in its version with a free-moving piston incorporating a piston damper shown enlarged in the right-hand-side representation.

FIG. 6 is a schematic section view perpendicular to the main pivot axis, similar to FIG. 2, of another embodiment of a pendulum-piston thermal machine in accordance with the present invention, in a two-stroke cycle internal combustion engine version with motion conversion mechanism. An upper representation of the figure illustrates the pendulum-piston in the compression phase of the air/fuel mixture of the working gas in the main chamber, an intake non-return valve opened for admission of air through an intake port into the pre-compression chamber. A lower representation of the figure illustrates the pendulum-piston at the end of the expansion stroke in the main chamber with intake and exhaust transfer working gas access ports (or gaps) opened, and with an exhaust of burned gases through an exhaust port of the exhaust chamber and the intake non-return valve closed.

FIG. 7 is a schematic front view of another motion conversion mechanism of the embodiment of FIG. 6 of the pendulum-piston thermal machine whose dynamic behaviors are different during the back-and-forth strokes of the pendulum-piston.

### DETAILED DESCRIPTION OF THE INVENTION

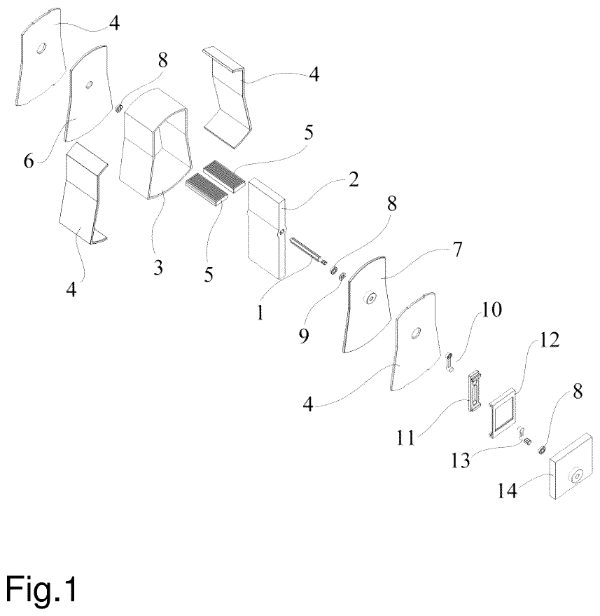

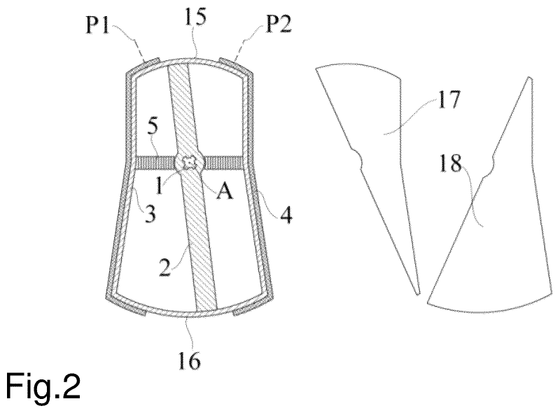

With reference to FIGS. 1 and 2, there is shown an embodiment of a pendulum-piston machine in accordance with the present invention for production of mechanical work or cooling using a working fluid or gas. The pendulum-piston machine comprises a main shaft (1) defining a main axis (A) thereof, a (pendulum-) piston (2) connected to the main shaft (1) and having a reciprocating movement around the main axis (A). The piston (2) has a plate connecting to the main shaft (1) and extending in a plane generally parallel to the main axis (A). The plate has sides edges (illustrated as top and bottom side edges) being opposite to one another relative to the main axis (A). The machine further comprises a casing receiving the piston (2) therein and the main shaft (1) extending therethrough. The casing has a (peripheral) side wall (3) generally extending around the main axis (A) and defining two side wall surfaces (illustrated as top and bottom arcuate surfaces) thereof opposite one another relative to the main axis (A). The two side wall surfaces have a generally concave revolution (circular) shape, and typically a concave cylindrical shape as the sides edges are typically rectilinear and parallel to the main axis, centered about the main axis (A) (on a section perpendicular thereto—as seen in the section view of FIG. 2), and each said side edge is adapted to be adjacent (follow, assume) and slide (with a gastight seal there between) along a respective said side wall surface during the reciprocating movement of the piston (2). The piston (2) and the casing define at least one working chamber (two working chambers are illustrated in the left-hand-side representation of FIG. 2, on both the left and right sides of the piston (2)) there between on one side of the piston (2) and fillable with the working fluid. The machine has an asymmetry to allow a volume of the working chamber to vary during the reciprocating movement of the piston (2) within the casing, as illustrated in the right-hand-side representation of FIG. 2) with the minimum (17) and maximum (18) volumes of the working chamber located on the right-hand-side of the piston (2)). It is noted that, without departing from the scope of the present invention, one skilled in the art would readily understand that anyone or both of the side wall surfaces could have a convex shape on a section thereof taken in a plane parallel to the main axis.

Typically, the main axis (A) is closer to one of the sides edges relative to the other one of the sides edges, as illustrated with the top edge of the piston (2) being closer to the main axis (A) than the bottom edge of the piston (2).

In the case of the thermal machine operating with the Stirling cycle or the cycle derived from Stirling cycle (external combustion engine or refrigerating machine), the machine typically consists of two or three essential parts, depending on the application.

The moving part is typically represented by the piston (2), or pendulum-piston (2), with its main shaft (1) and the bearings (8) that support it. The pendulum-piston (2) pivots on the axis (A). Its two sliding faces (or side edges) parallel to the pivot axis (A) are slightly arched or curved to better assume the circular shapes of the side wall surfaces whose center coincides with the pivot axis (A), and typically slightly convex in a plane perpendicular to the pivot axis (A). The pendulum-piston (2) has a geometric asymmetry relative to the pivot axis (A), such that there is an inequality between the two radiuses of the two rounded side edges of the pendulum-piston (2).

The fixed part is typically represented by the casing, the enclosure which contains the pendulum-piston (2), a porous element (as the thermal regenerator (5)) typically located between top and bottom ends of the working chamber (adjacent a respective one of the top and bottom side wall surfaces), and the working fluid or gas.

The casing typically includes the peripheral side wall (3) and two flanges or lateral walls (6, 7), facing each other with the (peripheral) side wall (3) extending there between and connected thereto, and in which the bearings (8) and the seal (9) are housed. The peripheral side wall (3) and two lateral walls (6, 7) define and enclose a room containing the at least one, or both working chambers as illustrated in FIG. 2. The pendulum-piston (2) slides onto and along the two lateral walls (6, 7) via typically flat lateral faces or edges of the plate, with a gastight (or airtight) seal there between. The two inner faces (or top and bottom side wall surfaces), typically at the top and bottom ends of the side wall (3), on which the pendulum-piston (2) slides, are arched, arcuate or curved along circles whose center coincides with the main pivot axis (A), and its shapes are a concave revolution, and preferably a concave cylindrical revolution, being circular in the plane perpendicular to the main pivot axis (A). The hot (15) and cold (16) thermal sources are located in or adjacent the two curved top and bottom side wall surfaces of the peripheral side wall (3). Two thermal insulating coatings (4) typically surround and envelop the lateral wall (3) and lateral walls (6, 7) of the entire casing, leaving only two openings adjacent the side wall surfaces (or the arched portions) of the peripheral side wall (3) (representing the hot (15) and cold (16) heat sources), and the outlet orifice for the main piston shaft (1) on the lateral wall (7). The pendulum-piston (2) typically separates the enclosure room defined by the casing into two volumes containing the working gas and constituting the two working chambers. The thermal regenerator (5) is located approximately in the middle of the working chambers and typically extends between the peripheral side wall (3), the two lateral walls (6, 7), and the pendulum-piston (2). The opposing faces of the thermal regenerator (5) and the pendulum-piston (2) are typically arched or curved in in arcs whose centers coincide with the pivot axis (A) so that the pendulum-piston (2) can move without knocking on the thermal regenerator (5).

Optionally, a mechanism for converting the rotary reciprocating motion of the pendulum-piston (2) and its shaft (1) has a continuous rotary motion, in the case where the pendulum-piston (2) is not free-moving.

Still referring to FIGS. 1 and 2, the present invention is essentially based on the geometric asymmetry of the pendulum-piston (2) regarding its main pivot axis (A). Due to this asymmetry, the resultant of the gas pressure on the pendulum-piston (2) is a torque at the main axis (A) moving the pendulum-piston (2), thus the pendulum-piston (2) plays the role of a power piston. On the other hand, the thermodynamic cycles of the gas in the working chambers are out of phase with each other by half a period. Due to this phase shift, the torque at the main axis (A) changes direction cyclically alternating the direction of movement without the need for a massive flywheel or return spring. In addition, the fact that the pendulum-piston (2) pivots about the main axis (A), it pushes the gas from one arched side (top or bottom, relative to the main axis A)) to the other for each (left and right sides) working chamber moving the gas from one thermal source (top and bottom side wall surfaces) to the other, therefore the pendulum-piston (2) also plays the role of the displacer piston.

When the pendulum-piston (2) is at the angular far-left-most stop position (P1), the working chamber on the right side is at its minimum volume (17). The gas occupying it is mainly located between the thermal regenerator (5) and the hot thermal source (15) to which it is only exposed with its entire area. This causes the gas to heat up and therefore its pressure increases. At the same time, on the other face or lateral side of the pendulum-piston (2), the working chamber on the left side is at its maximum volume. The gas occupying the left side working chamber is mainly located between the thermal regenerator (5) and the cold thermal source (16), to which it is only exposed with its entire area. This causes the gas to cool down and therefore its pressure decreases. Consequently, a pressure difference is created on the two faces of the pendulum-piston (2). As it is asymmetrical with respect to the pivot axis (A), this pressure difference is manifested by a torque exerted on the pendulum-piston (2), moving it to the other angular far-right-most stop position (P2). The volume of the working chamber which is on the right side increases. The gas expands and moves by the action of the pendulum-piston (2) towards the cold thermal source (16) by crossing the thermal regenerator (5), while being heated by the hot thermal source (15) with its entire area. At the same time on the other face or lateral side of the pendulum-piston (2), the volume of the working chamber which is on the left decreases. The gas compresses and moves by the action of the pendulum-piston (2) towards the hot thermal source (15) by crossing the thermal regenerator (5), while being cooled by the cold thermal source (16) with its entire area.

When the pendulum-piston (2) reaches about a quarter of its stroke, the gases in both working chambers begin to be exposed to both the hot heat source (15) and the cold heat source (16). So, for the working chamber on the right side, the contact surface with the hot heat source (15) begins to decrease, and the contact surface with the cold heat source (16) begins to increase. At the same time on the other lateral side of the pendulum-piston (2), for the working chamber on the left side, the contact surface with the hot heat source (15) begins to increase, and the contact surface with the cold heat source (16) begins to decrease.

Once the pendulum-piston (2) reaches about three-quarters of its stroke, the gases in the working chambers begin to be exposed only to a single heat source. In this way, the gas in the working chamber on the right side is exposed only to a cold heat source (16) with its entire area. This causes the gas to cool down and its pressure to decrease. At the same time, on the other lateral side of the pendulum-piston (2), the gas in the working chamber on the left side is exposed only to a hot heat source (15) with its entire area. This causes the gas to heat up and its pressure to increase. Consequently, the pendulum-piston (2) slows down until it stops at the angular far-right-most stop position (P2) and thus, it completes a half cycle for each working chamber. The working chamber on the right side becomes at its maximum volume (18), and the gas occupying it is concentrated between the thermal regenerator (5) and the cold heat source (16). At the same time on the other lateral side of the pendulum-piston (2), the working chamber which is on the left side becomes at its minimum volume, and the gas which occupies it is concentrated between the thermal regenerator (5) and the hot thermal source (15).

From the angular far-right-most stop position (P2), the pendulum-piston (2) begins its return stroke in the opposite direction towards the angular far-left-most stop position (P1), to complete the remaining half-cycle, following the steps previously described for the left working chamber applied for the right working chamber. And similarly following the steps previously described for the right working chamber applied for the left working chamber.

During half of the stroke of the pendulum-piston (2), the gas is exposed to both hot and cold thermal sources. The fact that the pendulum-piston (2) is at about its maximum speed during this half of the stroke results in a very short time compared to the cycle period, which limits energy losses.

The configuration of the thermal machine with Sterling cycle described in the cycle description has the hot (15) and cold (16) heat sources directly anchored to the side wall surfaces of the casing. This configuration is suitable for the use of solar radiation as energy and that the part of the peripheral side wall (3) representing the hot heat source (15) is transparent to this radiation. By penetrating the hot heat source (15), the solar radiation directly heats the gas contained in each working chamber without causing excessive thermal deformation for this thermal machine.

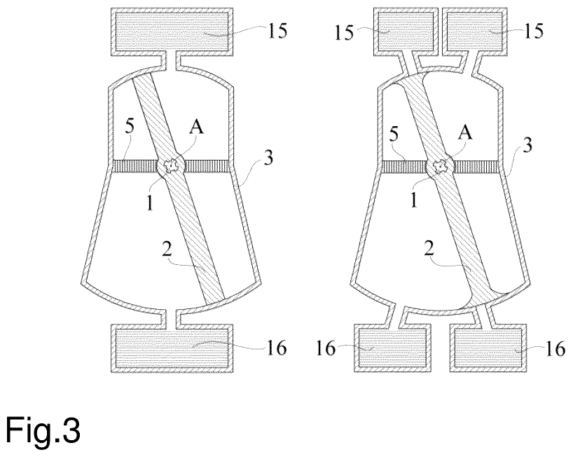

Several other configurations can be considered to limit the thermal deformation of the casing due to the temperature difference between the two sides where the thermal sources are located, such as, for example:
Having the thermal sources on the flat parts perpendicular to the main pivot axis (A), such as the lateral walls (6, 7). Therefore the thermal deformation can be contained by the ability of these flat parts representing the thermal sources to slide on the remaining parts of the casing, when they thermally expand or contract, without excessively affecting the remaining parts that constitute the casing.
Having the thermal sources represented by heat exchangers for the gas contained in the working chambers, such as heaters for the hot thermal source (15) and coolers for the cold thermal source (16). These exchangers are connected by ducts to the pendulum-piston thermal machine, as illustrated in FIG. 3. The access of the gas to these exchangers depends on the position of the pendulum-piston (2). For this configuration, the presence of thermal insulating coating (4) has no significant effect on the energy efficiency of the machine. In the case where the pendulum-piston thermal machine is equipped with a single exchanger for each source, the ducts are positioned in the middle of the stroke of the pendulum-piston (2), as illustrated in the left-hand-side representation of FIG. 3. These exchangers are shared between the two working chambers and the thermodynamic cycle differs from that described previously. In the case where each working chamber has its own exchangers, the ducts are connected at a quarter and three-quarters of the stroke of the pendulum-piston (2), as illustrated in the right-hand-side representation of FIG. 3. The pendulum-piston (2) obstructs these ducts by its passage, thus making it possible to reproduce a thermodynamic cycle closer to that described previously. Each duct connecting the heat exchanger to the working chamber can be doubled and equipped with one-way passive valves, in order to improve the circulation of the gas as well as the heat transfer inside each heat exchanger.

The pendulum-piston thermal machine with Stirling cycle is the equivalent of having two extremely compact and lightweight juxtaposed Stirling engines, but equipped with a single piston for both, at the same time ensuring both roles of power piston and displacer piston, thereby reducing pressure drops when the gas moves between the thermal sources. In addition, the thermodynamic cycles of the gas in the working chambers are half-period out of phase with each other. Therefore, the pendulum-piston thermal machine delivers power continuously and not cyclically despite having only one moving part.

The casing is typically perfectly sealed, as it would be essentially almost impossible for the gas from the two working chambers to leak to the outside environment or to be contaminated by the outside environment. In addition, pumping losses are inexistent and the noise is reduced, since the pendulum-piston (2) is isolated from the outside environment.

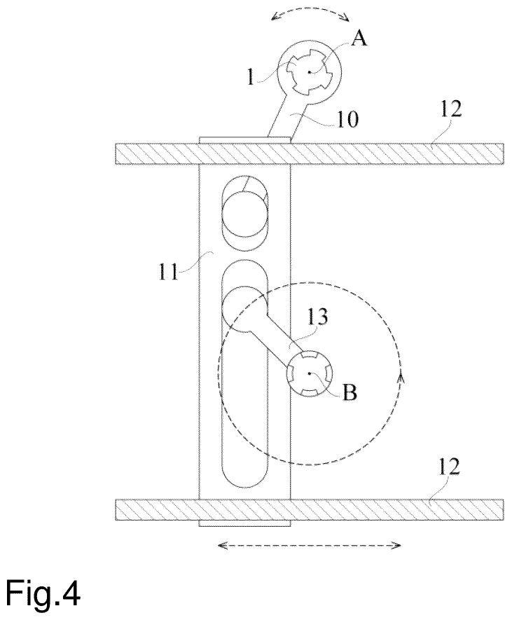

Several mechanisms can be used to convert the reciprocating rotary motion of the pendulum-piston (2) into continuous rotary motion. The one suggested is based on a Scotch Yoke, the movements of the parts that compose it, all are on the same plane, as illustrated in FIG. 4. In addition, this mechanism allows to have the same dynamic behavior for both working chambers (dynamic behavior during the reciprocating strokes of the pendulum-piston is identical). A pendulum crank (10) is directly attached to the piston main shaft (1) thus, it reproduces the reciprocating rotary motion of the pendulum-piston (2). This pendulum crank (10) drives a frame (11) by its eccentric part in order to convert the reciprocating rotary motion into a translational reciprocating motion. The frame (11) typically slides on the guides of a slide member (12) attached to a mechanism casing (14) and this frame (11) drives a rotary crank (13) supported by a bearing (8). An eccentric part of the rotary crank (13) slides inside the frame (11). Therefore, a continuous rotary movement is produced whose axis of rotation is (B), typically parallel to the main axis (A) and in line with the plate of the pendulum-piston (2) when the latter is in the half-stroke position (when the two working chambers have a same volume, in the embodiments of FIGS. 1 to 3). To eliminate any vibration of the parts that constitute the mechanism without adding a counterweight, during the operation of the thermal machine equipped with the motion conversion mechanism, it would be preferred or advised to have two coupled pendulum-piston thermal machines whose respective positions of the pendulum-pistons are symmetrical to each other, in order to have the global center of gravity permanently fixed. Remembering that the configuration of this thermal machine provides the advantage of having the motion conversion mechanism isolated in a confined compartment far from thermal sources.

The free-moving piston version of the present invention has the advantage not only of not requiring much modification compared to the version equipped with the motion conversion mechanism, but it can also operate without any return spring. This is due to the presence of the working chambers whose thermodynamic cycles are out of phase by half a period, on each side of the pendulum-piston (2).

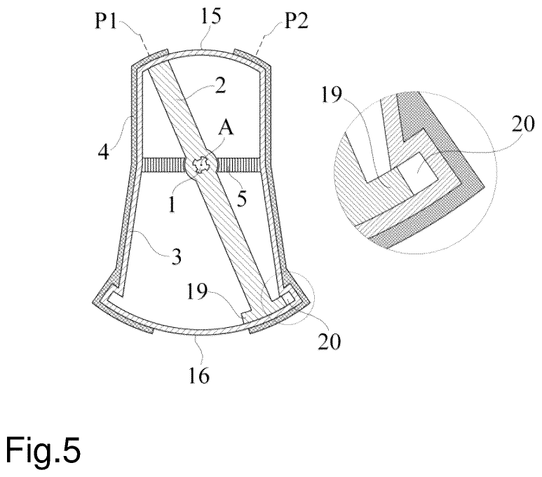

On the other hand, as illustrated in FIG. 5, in order to prevent the pendulum-piston (2) by its inertia from hitting the peripheral casing (3), when it reaches the end of its stroke, each working chamber of the thermal machine version free-moving piston is typically equipped with at least one piston damper including:
Micro-pistons (19) playing the role of small piston, and which typically consist of protrusions extending from typically the two faces of the pendulum-piston (2) or the peripheral wall (3) of the casing in contact with the two working chambers; and
Micro-bores (20) playing the role of small cylinders for the respective micro-pistons (19), and which consist of cavities extending (or formed) into typically the two faces of the peripheral wall (3) or the pendulum-piston (2), opposite faces of the pendulum-piston (2) or the peripheral wall (3) on which the micro-pistons (19) are located. The micro-bores (20) have about the same shape but with slightly larger dimensions than the micro-pistons (19) for operating clearances.

When the pendulum-piston (2) is at the end of its stroke, the micro-piston (19) encloses a quantity of gas in the corresponding micro-bore (20). This enclosed gas acts as an air spring/damper when the micro-piston (19) slides in the micro-bore (20), thus ensuring that the pendulum-piston (2) slows down and stops before it strikes the peripheral wall (3). In order for the micro-piston (19) and the micro-bore (20) to fit together, while ensuring a good level of sealing of the enclosed gas, their faces which are in opposition to the hot (15) and cold (16) thermal sources are slightly arched along circles whose center coincides with the main pivot axis (A).

To eliminate any vibration during operation of the free-moving piston version of the pendulum-piston thermal machine, to one needs to ensure that the center of gravity of the pendulum-piston (2) is located on the main pivot axis (A).

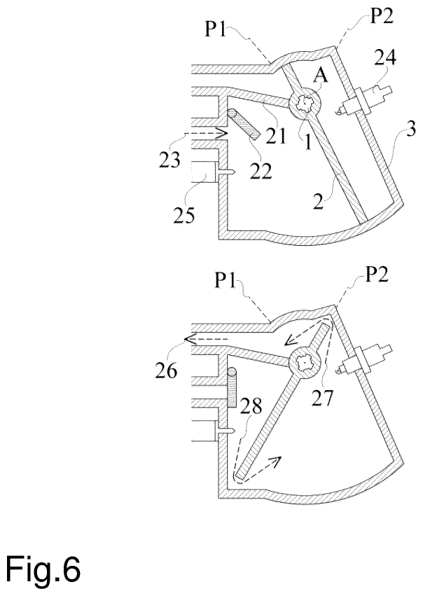

Now referring more specifically to FIG. 6. there is shown another embodiment of a pendulum-piston thermal machine in accordance with the present invention configured as an internal combustion engine, the machine keeps the same structure except for a few differences:
absence of thermal insulation (4) that envelops the casing given that there are no external hot and cold sources.
absence of the porous element as the thermal regenerator (5).
need to have intake and exhaust ports.
need to have components such as spark plugs and/or fuel injectors.
a geometric asymmetry of the pendulum-piston (2) regarding the main pivot axis (A) is more evident for the internal combustion version due to the required higher adequate compression ratio of the working fluid or gas mixture.

To adapt the pendulum-piston thermal machine into an internal combustion engine with a four-stroke combustion cycle, it is typically necessary to add for each working chamber, a distribution (valvetrain or valve gear drive), valves and intake and exhaust ducts typically in the peripheral wall (3) of the casing, as further detailed hereinbelow.

The best configuration of a pendulum-piston thermal machine in the internal combustion engine version is a two-stroke combustion cycle. Unlike the four-stroke combustion cycle or the Sterling cycle version, the two working chambers are not equal. One of them (the one illustrated on the left-hand-side of the piston (2) in FIG. 6) is divided into two, i.e. first and second sub-chambers isolated by a dividing plate or separator (21). The separator (21) is typically a wall forming part of the casing and extending from the peripheral side wall (3), and located between the side wall (3), the two lateral walls (6, 7) and the pendulum-piston (2). The opposite meeting faces of the separator (21) and the pendulum-piston (2) are arched along circles whose centers coincide with the main pivot axis (A) so that the pendulum-piston (2) can slide on the separator (21) while ensuring a good sealing.

The three resulting chambers in the pendulum-piston thermal engine version of the two-stroke combustion cycle internal combustion engine are:
The main or combustion chamber: in which combustion takes place. It corresponds to the closed space between the pendulum-piston (2), the lateral walls (7, 8) and the peripheral side wall (3), and illustrated on the right-hand-side of the piston (2) in FIG. 6. The combustion chamber can include a fuel injector (not shown) in the case of direct fuel injection and a spark plug (24) or the like in the case of controlled ignition.
The first mixing or pre-compression chamber (or first sub-chamber): corresponds to the closed space between the lateral walls (7, 8), the peripheral side wall (3), the separator (21) and a long-arm portion of the lever relative to the main pivot axis (A) of the pendulum-piston (2) which is the portion with larger geometric dimensions in the asymmetry of the pendulum-piston (2) relative to the main pivot axis (A). The pre-compression chamber typically includes an intake port (23) and a non-return valve (22) or the like. The pre-compression chamber may include a fuel injector (25) in the case where the fuel injection is indirect.
The exhaust chamber (or second sub-chamber): corresponds to the closed space between the lateral walls (7, 8), the peripheral side wall (3), the separator (21) and a short-arm portion of the lever relative to the main pivot axis (A) of the pendulum-piston (2) which is the portion with smaller geometric dimensions in the asymmetry of the pendulum-piston (2) relative to main pivot axis (A). The exhaust chamber includes the exhaust port (26).

When the pendulum-piston (2) is at the angular far-left-most stop position (P1). The spark plug (24) allows ignition and starts combustion, the working gases expand in the main chamber and the pendulum-piston (2) moves to the other angular far-right-most stop position (P2). At the same time on the other side of the pendulum-piston (2), the non-return valve (22) typically closes passively due to the imbalance pressure, thus the pendulum-piston (2) compresses the air or the air/fuel mixture present in the pre-compression chamber. The non-return valve (22) can be easily controlled, since it is located in a place with non-excessive temperatures and pressures and without any oil bath.

Once the pendulum-piston (2) arrives close to the angular far-right-most stop position (P2), the pendulum-piston (2) moves away from the peripheral side wall (3) on both top and bottom ends to create gaps between the piston (2) and the side wall (3), as illustrated on the lower representation of FIG. 6. These gaps constitute an intake transfer ports (28) on the long-arm portion lever side of the pendulum-piston (2), and an exhaust port (27) on the short-arm portion lever side of the pendulum-piston (2), respectively. The air or the air/fuel mixture, entering the main chamber from the pre-compression chamber through the intake transfer port (28), expels the burnt gases which are evacuated through the exhaust transfer port (27) towards the exhaust chamber. An uniflow scavenging of the burnt gases is being carried out, improving the filling with fresh gases and the evacuation of the burnt gases from the main chamber without risk of crossflow. When beginning its return stroke to the angular far-left-most stop position (P1), as illustrated on the upper representation of FIG. 6, the pendulum-piston (2), the pendulum-piston (2) closes the transfer ports (27, 28) and compresses the air/fuel mixture. At the same time, the pendulum-piston (2) creates a vacuum which opens the non-return valve (22) allowing air to enter the pre-compression chamber. Once it has returned to the angular far-left-most stop position (P1), the cycle can begin again.

The exhaust chamber serves as a second expansion chamber for the burnt gases, thus recovering some of the residual energy from the exhaust gases. Although not specifically illustrated, this is accentuated when two pendulum-piston thermal machines whose combustion cycles are out of phase with each other and whose exhaust chambers are connected. The exhaust chambers can be equipped with valves to better manage this second expansion.

The configuration of the pendulum-piston (2) offers the possibility of cooling it from the inside by passing a cooling fluid through its shaft (1), minimizing the risk of seizure while reducing the mechanical clearances of the parts, which improves the gas sealing.

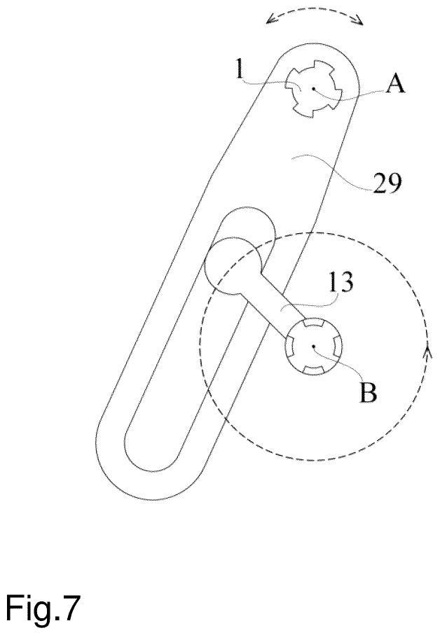

Since it is not important to have the same dynamic behavior for the pendulum-piston (2) during its reciprocating strokes of the two-stroke internal combustion engine, the mechanism for converting the reciprocating rotary motion of the pendulum-piston (2) can be simplified. As illustrated in FIG. 7, the crank-balancer parts (10, 11) and the slide member (12) are replaced by a single part, a balancer frame (29). The balancer frame (29) is directly attached to the piston shaft (1) thus, it reproduces the reciprocating rotary motion of the pendulum-piston (2). The balancer frame (29) drives the rotary crank (13), the eccentric part of which slides inside the frame part of the balancer frame (29). To eliminate any vibration during operation of the two-stroke cycle internal combustion engine with a pendulum-piston, equipped with a simplified motion conversion mechanism, it is sufficient to superimpose the center of gravity of the pendulum-piston assembly (2) and the balance frame (29) with the main pivot axis (A), and the center of gravity of the rotating crank (13) with its rotation axis (B).

This two-stroke cycle pendulum-piston internal combustion engine is capable of having a variable compression ratio depending on the load, by adjusting the size of the dead volume, as well as the opening gaps of the transfer ports (27, 28). This can be achieved by controlling the angular far-left-most and far-right-most stopping positions (P1, P2) of the pendulum-piston (2), which can be done:
by adding a hydraulic or electric phase shifter system between the pendulum-piston (2) and the balance frame (29); or
by the addition of a mechanical differential system which couples the pendulum-piston (2) with the balance frame (29) and the gear or lever by which the angular stop positions (P1, P2) are controlled.

The pendulum-piston internal combustion engine is modular in such a way that the machinery required to manufacture a given model is sufficient to have a range of engines of different power outputs. It is sufficient to couple together an adequate number of basic models.

1-12. (canceled)

13. A pendulum-piston machine for production of mechanical work or cooling using a working fluid, the machine comprising:
a main shaft defining a main axis thereof;
a piston connected to the main shaft and having a reciprocating movement around the main axis; the piston having a plate connecting to the main shaft and extending in a plane generally parallel to the main axis, the plate having sides edges being opposite to one another relative to the main axis;
a casing receiving the piston therein and the main shaft extending therethrough, the casing having a side wall generally extending around the main axis and defining two side wall surfaces thereof opposite one another relative to the main axis, the two side wall surfaces having a generally concave revolution shape centered about the main axis, each said side edge being adapted to be adjacent and slide along a respective said side wall surface during the reciprocating movement of the piston;
wherein the piston and the casing defining at least one working chamber there between on one side of the piston and fillable with the working fluid, the machine having a geometric asymmetry to allow a volume of the working chamber to vary during the reciprocating movement of the piston within the casing.

14. The pendulum-piston machine of claim 13, wherein the main axis is closer to one of the sides edges relative to the other one of the sides edges.

15. The pendulum-piston machine of claim 14, wherein the main axis extends within the plane defined by the plate of the piston.

16. The pendulum-piston machine of claim 14, wherein one of the side wall surfaces being connected to a hot thermal source and the other one of the side wall surfaces being connected to a cold thermal source.

17. The pendulum-piston machine of claim 14, wherein the working chamber defines top and bottom ends thereof adjacent a respective one of the side wall surfaces, the machine further comprising a porous element located between the top and bottom ends to allow a gas mixture within the chamber to freely flow therethrough.

18. The pendulum-piston machine of claim 13, wherein the casing includes lateral walls generally facing each other with the side wall extending between and connected thereto, the main axis extending through the lateral walls, the side wall and the lateral walls defining and enclosing a room containing the at least one working chamber.

19. The pendulum-piston machine of claim 13, further comprising a piston damper to reduce and stop a piston angular speed before the piston restart in an opposite angular direction.

20. The pendulum-piston machine of claim 19, wherein the piston damper includes a protrusion, extending from one of the piston and the casing in a circumferential direction about the main axis, selectively engaging a corresponding cavity extending into the other one of the piston and the casing.

21. The pendulum-piston machine of claim 13, wherein the concave revolution shape of at least one of the two side wall surfaces is a concave cylindrical shape.

22. The pendulum-piston machine of claim 13, wherein the piston and the casing defining two working chambers there between on either side of the plate of the piston.

23. The pendulum-piston machine of claim 22, wherein a first one of the two working chambers is divided into first and second sub-chambers divided by a dividing plate of the casing extending between the piston adjacent the main axis and the side wall of the casing, the first and second sub-chambers being selectively in fluid communication with a second one of the two working chambers for the working fluid to flow therebetween via displacement of the piston, the first sub-chamber being a mixing chamber, the second sub-chamber being an exhaust chamber, and the second one of the two working chambers is a combustion chamber.

24. The pendulum-piston machine of claim 23, wherein the mixing chamber is adapted to receive air and fuel therein, via at least one of a group consisting of an injector and an input opening selectively closable by a one-way valve, to get an air-fuel mixture of the working fluid therein.

25. The pendulum-piston machine of claim 24, wherein the exhaust chamber is adapted to reject at least a burned portion of the air-fuel mixture therefrom via an exhaust opening.

26. The pendulum-piston machine of claim 13, further including a phase shifter system connecting to the main shaft to control an angular amplitude of the reciprocating movement of the piston within the casing.

27. The pendulum-piston machine of claim 26, wherein the phase shifter system includes at least one of a group consisting of a mechanical, a hydraulic, and an electrical phase shifter.

28. The pendulum-piston machine of claim 13, wherein the piston has a center of gravity located on the main axis.

29. The pendulum-piston machine of claim 21, wherein the piston has a center of gravity located on the main axis.

30. The pendulum-piston machine of claim 22, wherein the piston has a center of gravity located on the main axis.
